(19) United States
(12) Patent Application Publication
(10) Pub. No.: US 2024/0211802 A1
(43) Pub. Date: Jun. 27, 2024

(54) HYBRID MACHINE LEARNING ARCHITECTURE FOR VISUAL CONTENT PROCESSING AND USES THEREOF

(71) Applicant: LUMANA INC., Sunnyvale, CA (US)

(72) Inventors: Ofir MULLA, Talme Elazar (IL); Noam ROTSTEIN, Haifa (IL); Amit BRACHA, Haifa (IL); Ron KIMMEL, Haifa (IL); Aviad ZABATANI, Kfar Vitkin (IL); Ron SLOSSBERG, Raanana (IL); Sagi BEN MOSHE, Ein Ayala (IL)

(73) Assignee: LUMANA INC., Sunnyvale, CA (US)

(21) Appl. No.: 18/145,301

(22) Filed: Dec. 22, 2022

(51) Int. Cl. G06N 20/00; G06T 7/10

(52) U.S. Cl. CPC G06N 20/00; G06T 7/10

(57) ABSTRACT

Systems and methods for visual content processing. A method includes obtaining a subset of media content selected based on outputs of a first machine learning model, wherein the first machine learning model is produced by training a student model using outputs of a teacher model, wherein the outputs of the first machine learning model include a plurality of first predictions for a plurality of portions of the media content; and applying a second machine learning model to the obtained subset of media content, wherein the second machine learning model outputs a plurality of second predictions for respective portions of the plurality of portions, wherein a domain used by the first machine learning model is a subset of a domain used by the second machine learning model.

### TECHNICAL FIELD

The present disclosure relates generally to processing content such as images using machine learning, and more specifically to using distributed machine learning architectures for processing content.

### BACKGROUND

With the rapid adoption of computerized monitoring technologies, the amount of media content being captured and processed has exploded in recent years. With this explosion of media content that needs to be analyzed and processed, the need for efficient ways to process this vast amount of data is more acute than ever. Video monitoring technologies are being used for many different purposes, such as home monitoring (e.g., video doorbells which watch for activity outside of a door), vehicle monitoring (e.g., systems which monitor video for parking or other vehicle-related violations), hospitality (e.g., video monitoring inside of hotels), and many more. Although software can be installed locally where the media content is captured, processing such large amounts of media content presents a challenge and not all sites are equipped with the computing resources to handle such processing.

Additionally, these monitoring technologies would benefit from solutions which facilitate central management. Many of these monitoring technologies are used by large companies with many sites worldwide. Solutions which allow for providing a single portal that manages all videos being captured at these various worldwide locations are therefore desirable.

Solutions which would more efficiently process large volumes of media content are therefore highly desirable.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for visual content processing. The method comprises: obtaining a subset of media content selected based on outputs of a first machine learning model, wherein the first machine learning model is produced by training a student model using outputs of a teacher model, wherein the outputs of the first machine learning model include a plurality of first predictions for a plurality of portions of the media content; and applying a second machine learning model to the obtained subset of media content, wherein the second machine learning model outputs a plurality of second predictions for respective portions of the plurality of portions, wherein a domain used by the first machine learning model is a subset of a domain used by the second machine learning model.

Certain embodiments disclosed herein also include a non-transitory computer readable medium having stored thereon causing a processing circuitry to execute a process, the process comprising: obtaining a subset of media content selected based on outputs of a first machine learning model, wherein the first machine learning model is produced by training a student model using outputs of a teacher model, wherein the outputs of the first machine learning model include a plurality of first predictions for a plurality of portions of the media content; and applying a second machine learning model to the obtained subset of media content, wherein the second machine learning model outputs a plurality of second predictions for respective portions of the plurality of portions, wherein a domain used by the first machine learning model is a subset of a domain used by the second machine learning model.

Certain embodiments disclosed herein also include a system for visual content processing. The system comprises: a processing circuitry; and a memory, the memory containing instructions that, when executed by the processing circuitry, configure the system to: obtain a subset of media content selected based on outputs of a first machine learning model, wherein the first machine learning model is produced by training a student model using outputs of a teacher model, wherein the outputs of the first machine learning model include a plurality of first predictions for a plurality of portions of the media content; and apply a second machine learning model to the obtained subset of media content, wherein the second machine learning model outputs a plurality of second predictions for respective portions of the plurality of portions, wherein a domain used by the first machine learning model is a subset of a domain used by the second machine learning model.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flow diagram illustrating continuous training of machine learning models in a hybrid machine learning architecture in accordance with various disclosed embodiments.

FIG. 3 is a flow diagram illustrating distributed processing of content in accordance with various disclosed embodiments.

FIG. 4 is a flowchart illustrating a method for processing visual content at an edge of a distributed architecture according to an embodiment.

FIG. 5 is a flowchart illustrating a method for training a student model for basic analysis according to an embodiment.

FIG. 6 is a flowchart illustrating a method for processing visual content at an advanced analyzer of a distributed architecture according to an embodiment.

FIG. 7 is a schematic diagram of a cloud analyzer according to an embodiment.

FIG. 8 is a schematic diagram of an edge analyzer according to an embodiment.

### DETAILED DESCRIPTION

The various disclosed embodiments include methods and systems making up a hybrid machine learning architecture for processing of visual content such as images as well as techniques for analyzing visual content using the hybrid architecture. The disclosed embodiments utilize a distributed architecture for machine learning training between a teacher model and a student model in order to train the student model to make predictions in line with the teacher model's predictions. Once the student model is trained in this way, the student model may be deployed at an edge device and utilized to make basic predictions about visual content in order to select potentially interesting portions of visual content for further analysis, to enlarge the set of teacher training content, or both. The potentially interesting portions of visual content may be provided to one or more advanced models, which may be deployed remotely (e.g., on a cloud server), for more detailed analysis. The outputs of the teacher model may be utilized for enriching the potentially interesting portions of the visual content with their respective analysis results, for generating more accurate student models whose outputs better fit the input visual content, or both. In various embodiments, enriched visual content may be provided for display on a dashboard.

At least some disclosed embodiments leverage a hybrid architecture including one or more edge analyzers and one or more remote analyzers such as cloud analyzers. Each of the edge analyzers is configured with an edge model trained with a cloud model used by the remote analyzers, where each edge model is trained as a student model by the cloud model acting as a teacher model. Each edge analyzer may be deployed on site or otherwise locally to a system that captures or otherwise collects visual content to be analyzed. Each remote analyzer may be deployed in a cloud computing environment or otherwise deployed remotely to the edge analyzers.

The disclosed embodiments may be utilized for image processing in situations where a large amount of image data is continuously collected in order to perform basic analysis of those images using the edge model and to only perform advanced analyses of the images when the basic analysis yields predictions indicating that those images are potentially interesting, for example, when the edge model outputs certain predictions about a classification or other characteristic of the image. To this end, in accordance with various disclosed embodiments, the student model may be trained on a subset of the feature domain used by the teacher model such that applying the edge model produced via training as the student model requires less processing than applying teacher model or other more advanced models. Accordingly, the disclosed embodiments can reduce total processing of content by limiting the amount of analysis performed using heavier models (e.g., models which have larger feature domains, more granular analysis, more kinds of outputs, otherwise require more processing, etc.) as enabled by a lighter model.

Additionally, the outputs of the edge model may be utilized in order to modify the content to be provided to the advanced models among the potentially interesting visual content. As a non-limiting example, portions of images identified as potentially interesting may be cropped from the images, and the cropped portions of the images may be sent for analysis by a cloud model acting as the advanced model. In this regard, the amount of processing performed by the advanced model, as well as network resources (e.g., bandwidth) used for transmitting the content, may be further reduced.

The hybrid approaches described herein can be utilized in order to allow customers or other end users to leverage their existing resources in order to preprocess image data for analysis by a remote system such as a cloud server. Specifically, the trained student model may be trained as a basic model, for example as an edge model utilized by an edge device, in order to perform basic analysis, and only certain portions of the content identified as potentially interesting based on the basic analysis may be sent to one or more advanced models, for example advanced models deployed as cloud models on a cloud device. This distribution of processing can enable new opportunities for processing content which would not be feasible due to high use of computing resources which would be needed to fully analyze all of the content directly using the advanced model, which may be a heavier model configured to make more accurate or more granular predictions than the basic model but requires more computing resources to run than the basic model.

In an example implementation, the disclosed embodiments can utilize a hybrid architecture including an edge server deployed on premises with a customer's cameras in order to apply the edge model to images captured locally by the customer's cameras. In this example, the edge model is configured to classify portions of images as either showing vehicles or not showing vehicles. Images or portions of images classified as showing vehicles based on the outputs of the edge server are determined as potentially interesting and sent from the edge server to a cloud server having the cloud model for further processing. An advanced model is configured to analyze additional potential characteristics of the vehicles identified by the edge model such as, for example, license plate number. The results of the cloud model analysis may be utilized to populate a dashboard for viewing by a user device of the customer.

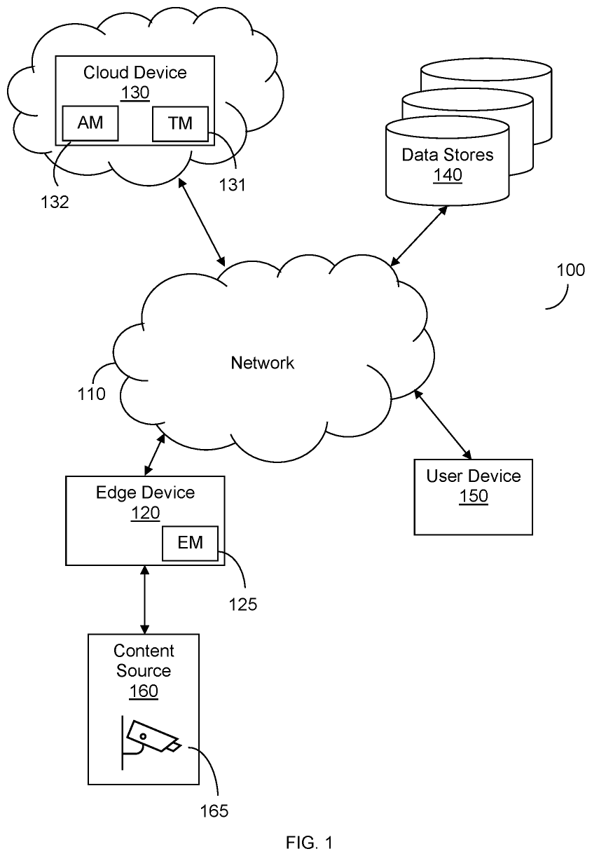

FIG. 1 shows an example network diagram 100 utilized to describe the various disclosed embodiments. In the example network diagram 100, an edge device 120, a cloud device 130, a plurality of data stores (hereinafter referred to individually as a data store 140 and collectively as data stores 140, merely for simplicity purposes), and a user device 150 communicate via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

Each of the edge device 120 and the cloud device 130 is configured to perform a respective portion of the embodiments described herein. More specifically, the edge device 120 is configured to apply an edge model (EM) 125 to features obtained from content, and the cloud device 130 is configured to apply a teacher model (TM) 131, an advanced model 132, or both, as discussed herein. In various embodiments and specifically as depicted in FIG. 1, the edge device 120 and the cloud device 130 are deployed remotely from each other.

During training, the edge model 125 is trained as a student model using the teacher model 131 to provide labels used for tuning of the student model. In at least some embodiments, the training may be performed on the cloud device 130, and both the edge model 125 and the cloud model 135 may be deployed on the cloud device 130. Once trained, the student model from the training is sent to the edge device 120 for deployment as the edge model 125 or otherwise deployed for use as a basic model which performs initial analysis to determine whether to further analyze portions of content by an advanced model.

The data stores 140 store content which may be used, for example, in order to train the student model, the teacher model 131, or both. Such content may include, for example, visual content illustrating objects to be analyzed. As a non-limiting example, the visual content may include video or image content showing a parking lot, where some portions of the video or images show cars which might be recognized via the edge model 125 and are analyzed further by the advanced model 132 as described herein.

The user device (UD) 150 may be, but is not limited to, a personal computer, a laptop, a tablet computer, a smartphone, a wearable computing device, or any other device capable of receiving and displaying notifications, portions of visual content, metadata, and the like. In various implementations, modified content created by the edge device 120 may be sent to the user device 150, and the user device 150 may be configured to display a dashboard containing such modified content.

The content source 160 includes (as shown) or is communicatively connected to (not shown) one or more sensors 165 such as, but not limited to, cameras. In accordance with various implementations, the content source 160 may be deployed “on-edge,” that is, locally with the edge device 120 (e.g., through a direct or indirect connection such as, but not limited to, communication via a local network, not shown in FIG. 1). Accordingly, the content captured or otherwise collected by the content source 160 may be analyzed initially using the edge model 125 at the edge, and then only certain portions of content determined to be of interest using the edge model 125 may be sent to the advanced model 132 for further processing.

It should be noted that various disclosed embodiments discussed with respect to FIG. 1 are described with respect to a cloud device 130 which is deployed remotely from an edge device 120, but that the disclosed embodiments are not necessarily limited as such. The systems utilizing the student model and the teacher model from the training may be deployed locally to each other, and may communicate over a local connection (e.g., via a local network). Likewise, the systems using the basic model which was trained as the student model and the advanced models may be deployed locally to each other without departing from the scope of the disclosure. The disclosed embodiments may still yield savings on processing when a first stage of processing is performed using the student model, and using the student model to decide which portions of visual content to send to the teacher model may reduce use of networking or other communication resources even when the systems storing and using the different models are deployed locally.

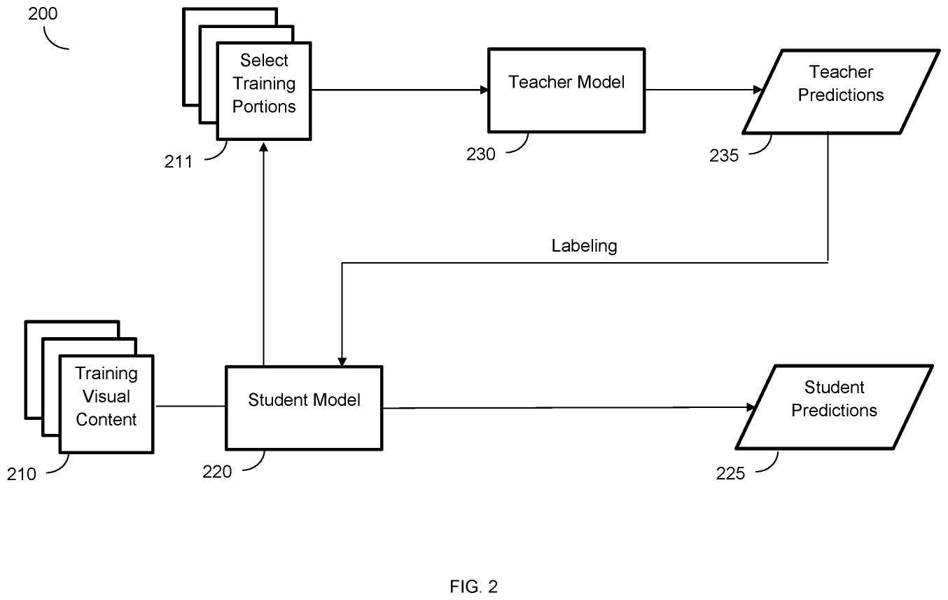

FIG. 2 is a flow diagram 200 illustrating continuous training of machine learning models in a hybrid machine learning architecture in accordance with various disclosed embodiments. More specifically, FIG. 2 illustrates fine tuning of a student model after initial training using a teacher model.

In FIG. 2, training visual content 210 is input to a student model 220, which is a machine learning model configured to make predictions about the training content 210. As a non-limiting example, the training content 210 may be images showing a parking lot in which vehicles park. Portions of the training content which are predicted by the student model 220 as potentially interesting (e.g., having a predetermined classification known to be potentially interesting) are selected and provided to the teacher model 230 as select training portions 211.

The teacher model 230 is pre-trained to make determinations about the select training portions 211. In an embodiment, the teacher model 220 is a classifier machine learning model trained to classify objects shown in images, for example, into classes such as type of object (e.g., vehicle or not vehicle, specific types of vehicles, etc.), recognized characters (e.g., letters and/or numbers), and the like. The teacher model 230 outputs a set of teacher predictions 235 corresponding to respective portions of the select training portions 211. Such teacher predictions 235 may include, but are not limited to, predictions of classifications (e.g., classifications matching labels among training data used for training the teacher model 230).

The teacher predictions 235 are used as inputs for fine tuning the student model 220. In particular, the teacher predictions 235 may be utilized to label features of respective portions of the training content 210, and the labeled portions of the training content 210 are provided as inputs to the student model 220. The student model 220 outputs a set of student predictions 225 for different portions of the training content 210. Because the outputs of the teacher model 230 are used as inputs to the student model 220, iteratively using the student model 220 to make predictions in this manner results in a student model which is trained to emulate the predictions made by the teacher model.

In various embodiments, the student model 220 is configured with a reduced feature domain as compared to the teacher model 230. That is, the universe of potential features recognized by the student model 220 may be a subset of the universe of potential features recognized by the teacher model 230. In this manner, the number of potential features to be analyzed by the student model at any given analysis is less than there would be for the teacher model 230 while generating predictions by the student model 220 which are highly similar to the predictions which would have been generated by the teacher model 230 when applied to the same content.

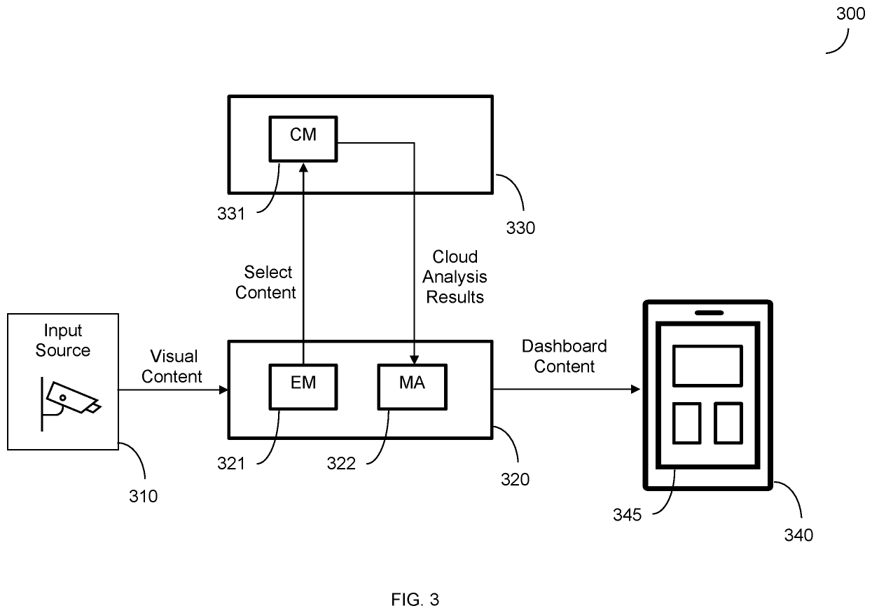

FIG. 3 is a flow diagram 300 illustrating a method for utilizing a hybrid machine learning architecture to efficiently process visual content between distributed systems in accordance with various disclosed embodiments.

In FIG. 3, an input source 310 provides content to be analyzed using an edge model (EM) 321 of an edge device 320 and a cloud model (CM) 331 of a cloud device 330. In accordance with various disclosed embodiments, the edge model 321 is configured to make predictions about the content when applied to features of the content. In turn, the edge device 320 is configured to utilize those predictions in order to determine which portions of the content from the input source 310 should be sent to the cloud model 331 for further analysis. For example, certain classes which might be output by the edge model 321 may be predetermined to be of interest such that portions of the content for which the edge model 321 predicts those predetermined interesting classes are determined as interesting and sent to the cloud model 331 for further analysis. In turn, the results of the further analysis may be returned to the edge device 320 and combined with the results of the basic analysis performed on the edge device 320 in order to generate content for populating a dashboard 345 on a user device 340.

Further, the edge device 320 may be configured to modify the content from the input source 310. As a non-limiting example, images from the input source 310 may be cropped to remove uninteresting portions. In various embodiments, only the modified content may be sent to the cloud model 331 for further analysis, thereby conserving computing resources for processing such modified content as compared to larger portions of content (e.g., cropped out portions of images instead of entire images).

In various embodiments, outputs of the cloud model 331 are returned to the edge device 320 for further use. In particular, the edge device 320 may also have installed thereon a metadata analyzer (MA) 322 which is configured to analyze the outputs of the cloud model 331 as metadata for the respective interesting portions of content identified by the edge model 321.

The edge device 320 may be further configured, for example, to enrich or otherwise modify the content using the output of the cloud model 331 in order to provide enriched content which may be displayed, for example, on a dashboard 345 of a user device 340. In some implementations, the dashboard 345 may show various portions of the content, specifically the portions identified by the edge model 321 as potentially interesting. In some further implementations, the content displayed on the dashboard 345, when interacted with (for example, by clicking, tapping, etc.) may be enhanced using the enrichment metadata. As a non-limiting example, when an interesting portion of content is a cropped portion of an image showing a car, the enrichment metadata may include information like a type of car, a license plate number of the car, and the like, such that interacting with the cropped portion of the image showing the car results in additional information including the type of car and license plate number of the car being displayed on the user device 340.

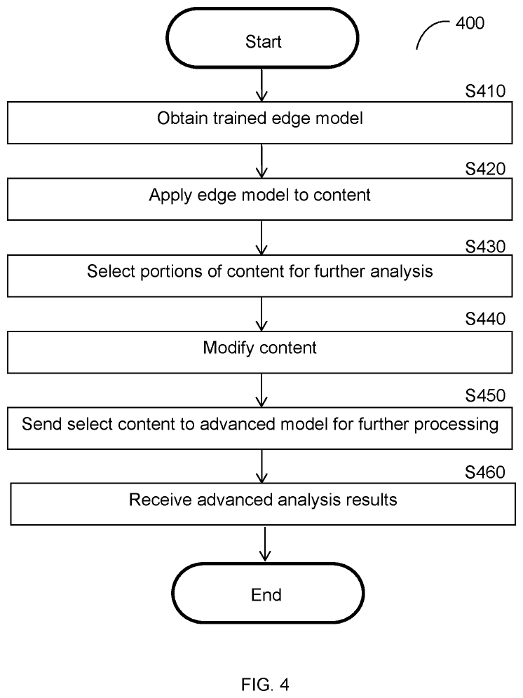

FIG. 4 is a flowchart 400 illustrating a method for processing visual content at an edge of a distributed architecture according to an embodiment. In an embodiment, the method is performed by the edge device 120, FIG. 1.

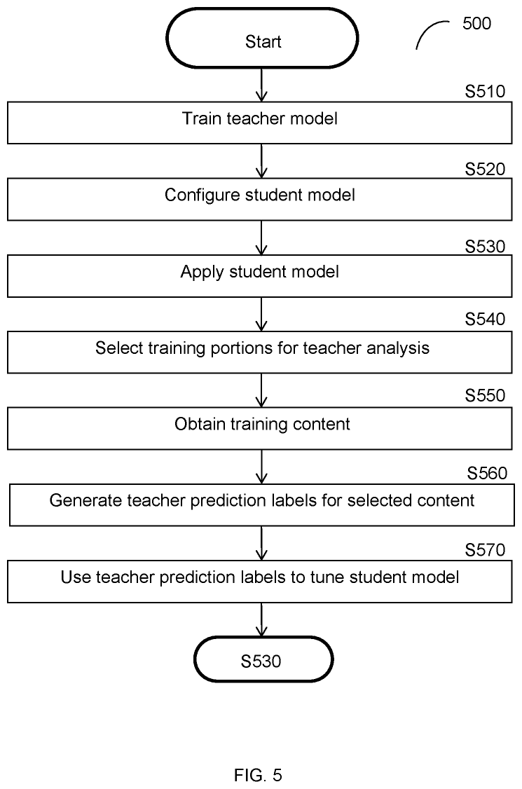

At S410, a trained edge model is obtained. The trained edge model may be received, for example, from a cloud device (e.g., the cloud device 130, FIG. 1). In various embodiment, the edge model is trained as a student model as described herein. In an embodiment, the student model is trained as described further below with respect to FIG. 5.

Specifically, a teacher model may be applied to features of content in order to generate teacher predictions, and the predictions output by the teacher model may be utilized as inputs to fine tune the student model such that the student model becomes trained to make similar predictions to the teacher model, albeit in a potentially different domain. In particular, the domain (i.e., the universe of potential features) used by the student model may be a smaller set of features than that of the teacher model. The student model trained in this manner may be received and then deployed at the edge device.

At S420, the obtained edge model is applied to features of content in order to generate a set of student predictions. The student predictions may be in forms such as, but not limited to, outputs of classifications reflecting labels known to a teacher model.

In an embodiment, the edge model is deployed at and stored on an edge device such as the edge device 120, FIG. 1. In a further embodiment, the edge device is deployed locally to a source of the content to be analyzed (e.g., the content source 160, FIG. 1) and is communicatively connected to that source of content so as to obtain the content to be analyzed. To this end, the edge device may communicate locally with that source using local communication channels such as, but not limited to, a wired connection, wireless direct connections (e.g., Bluetooth), local network connections (e.g., via a local area network), and the like.

At S430, portions of the content to be further analyzed are selected. In an embodiment, at least a subset of the potential student predictions which the student model is configured to output are predetermined as a set of predetermined predictions to be further analyzed. More specifically, predictions which are of interest based on predetermined designations such as inputs from one or more users are defined in rules used for determining which portions of content are to be further analyzed. To this end, S430 may include applying such rules to student predictions corresponding to respective portions of the content in order to determine whether each portion is among the set of predetermined predictions to be further analyzed.

At optional S440, at least some of the content may be modified. As a non-limiting example, image content may be cropped to only include the portions of the images which were identified as interesting and to be further analyzed at S430.

At optional S450, some or all of the content may be sent to an advanced model (e.g., the advanced model 132, FIG. 1) for further processing. More specifically, portions of content which were selected for further analysis at S430 are sent to be further analyzed. When the content is images, the sent content may include images containing portions identified as interesting at S430 or portions of the image identified as interesting cropped out of their respective images.

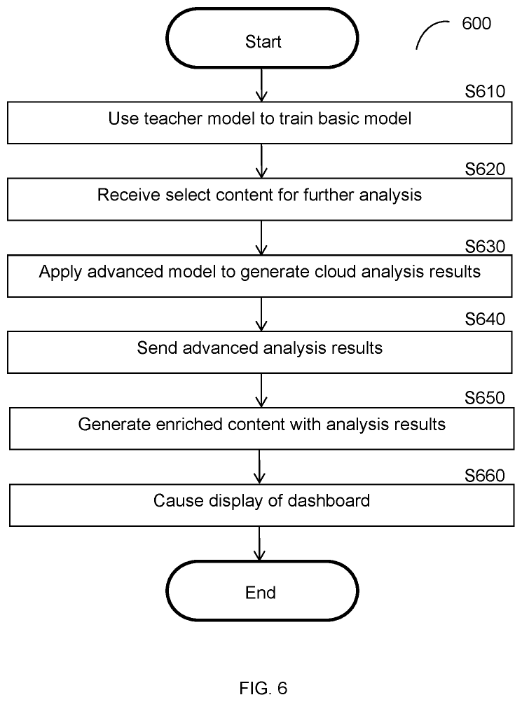

At S460, advanced analysis results are received from the advanced model. The advanced analysis results may include or otherwise be based on advanced model predictions made by a cloud model such as, but not limited to, the advanced model 132, FIG. 1. In an example implementation, the advanced model predictions may be generated as described further below with respect to FIG. 6.

FIG. 5 is a flowchart 500 illustrating a method for using a teacher model to train a student model for basic analysis according to an embodiment. In an embodiment, the method is performed by the cloud device 130, FIG. 1.

At S510, the teacher model is trained. In an embodiment, the teacher model is a classifier model trained via supervised machine learning using a training set including example features of content and respective labels representing known classifications. The teacher model is configured with a first domain, i.e., a first set of potential values that are recognized by the teacher model. The potential values recognized by the teacher model are values which can be input to the teacher model in order to produce teacher predictions, for example, values which correspond to variables within the teacher model.

At S520, a student model is configured with an initial configuration. The initial configuration of the student model is based on a second domain, i.e., a second set of potential values that are recognized by the student model. The second domain of the student model may be a subset of the first domain of the teacher model. The student model may be a classifier. To this end, the initial configuration of the student model may further define classes to be potential outputs for the student model. The classes output by the student model include classes which are also potential outputs of the teacher model, and may be a subset of the potential output classes of the teacher model.

At S530, the student model is applied to a first set of media content which includes potential training content in order to output a set of student predictions. The student predictions may be, but are not limited to, classifications (e.g., the classifications the student model is initially configured with as noted above).

At S540, portions of the potential training content are selected for further analysis based on the predictions output by the student model. The selected portions may include, for example, portions having certain classes which are predetermined to be potentially interesting and therefore candidates for further analysis.

It should be noted that the portions of the potential training content for further analysis are selected automatically and without requiring human intervention. By using the student model to select the content for further analysis during the training, such selection can be performed without requiring selection by a human operator. Moreover, since the student model is used for selection without requiring a human involved, privacy of the data can be maintained during the training process.

At S550, training content is obtained based on the portions selected at S540. Obtaining the training content may further include cropping or otherwise modifying the content based on the selections in order to prepare the content to be further analyzed by the teacher model.

At S560, teacher prediction labels are generated based on teacher predictions for the obtained training content. In an embodiment, the teacher prediction labels include one or more labels corresponding to each portion of the training content features (and, consequently to respective portions of the training content). In an embodiment, S560 includes applying the teacher model to the select training content selected by applying the student model as described above in order to generate a set of teacher predictions. For example, the teacher predictions may include, but are not limited to, predictions of certain classifications for respective portions of the training content features, percentages indicating a likelihood of each classification for each portion of the training content features, or both.

At S570, the teacher prediction labels are used to tune the student model. To this end, the teacher prediction labels may be provided to a training program used to train the student model. More specifically, the teacher prediction models may be used as feedback with respect to predictions made by the student model in order to fine-tune the student model.

FIG. 6 is a flowchart 600 illustrating a method for processing visual content at a cloud analyzer of a distributed architecture according to an embodiment. In an embodiment, the method is performed by the cloud device 130, FIG. 1.

At optional S610, the cloud model is used to train an edge model in order to make predictions in line with the predictions made by the cloud model. In an embodiment, the training of the edge model may be performed at least partially as described above with respect to FIG. 5. It should be noted that the training of the basic model is depicted as part of the process of FIG. 6 merely for illustration, and that the training of the basic model may be performed as part of an entirely separate process without departing from the scope of at least some disclosed embodiments.

At S620, content or portions thereof to be further analyzed by an advanced model is obtained. As noted above, the content or portions thereof include portions identified as potentially interesting based on predictions for the content made by a basic model. The content or portions thereof may include the content itself, subsets of the content, features extracted from the content, and the like.

At S630, the advanced model is applied in order to generate advanced analysis results. The analysis results may include, but is not limited to, one or more advanced predictions for each portion of the content being analyzed by the advanced model.

At S640, the advanced analysis results are sent for subsequent use. For example, the results may be sent to a system (e.g., the edge device 120) for use in enriching the portions of content as discussed above.

At optional S650, a set of enriched content may be generated using the cloud analysis results. The enriched content may include objects of the content (e.g., images) including interesting portions or the interesting portions themselves (e.g., cropped images, video clips, etc.), enriched with metadata related to the enriched content. More specifically, the enriched metadata may include metadata describing the student predictions, the teacher predictions, or both. As noted above, the teacher predictions may be selected from a larger set of potential outputs than that of the student model, from different sets of potential outputs than those of the student model, or both. The enriched content may be, but is not limited to, various portions of content each with one or more associated interactable elements and corresponding metadata. Also noted above, the enriched content may be generated by the device or system which received the advanced analysis results sent at S640.

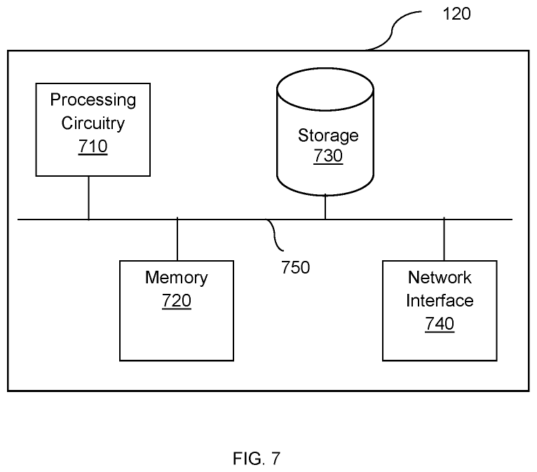

At optional S660 a dashboard including the enriched content may be caused to be displayed. To this end, S660 may include sending the enriched content for use with populating such a dashboard or generating the dashboard including the enriched content. FIG. 7 is an example schematic diagram of an edge analyzer 120 according to an embodiment. The edge analyzer 120 includes a processing circuitry 710 coupled to a memory 720, a storage 730, and a network interface 740. In an embodiment, the components of the edge analyzer 120 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 720 may be volatile (e.g., random access memory, etc.), non-volatile (e.g., read only memory, flash memory, etc.), or a combination thereof.

In one configuration, software for implementing one or more embodiments disclosed herein may be stored in the storage 730. In another configuration, the memory 720 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 710, cause the processing circuitry 710 to perform the various processes described herein.

The storage 730 may be magnetic storage, optical storage, and the like, and may be realized, for example, as flash memory or other memory technology, compact disk-read only memory (CD-ROM), Digital Versatile Disks (DVDs), or any other medium which can be used to store the desired information. The storage 730 may store, among other things, a teacher model (e.g., the cloud model 135) configured and utilized as described herein.

The network interface 740 allows the edge analyzer 120 to communicate with, for example, the cloud analyzer 130, the data stores 140, the content source 160, combinations thereof, and the like.

It should be understood that the embodiments described herein are not limited to the specific architecture illustrated in FIG. 7, and other architectures may be equally used without departing from the scope of the disclosed embodiments.

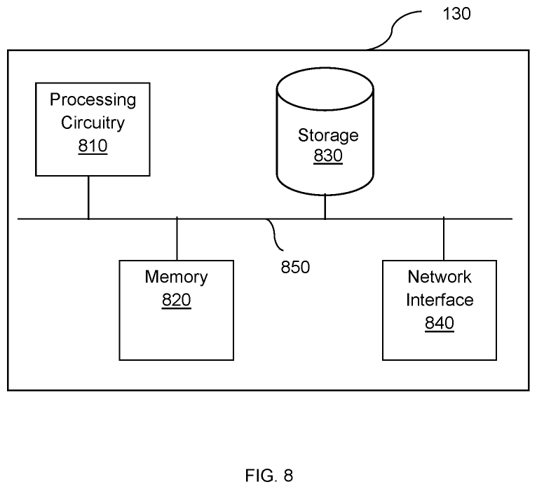

FIG. 8 is an example schematic diagram of a cloud analyzer 130 according to an embodiment. The cloud analyzer 130 includes a processing circuitry 810 coupled to a memory 820, a storage 830, and a network interface 840. In an embodiment, the components of the edge analyzer 130 may be communicatively connected via a bus 850.

The processing circuitry 810 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 820 may be volatile (e.g., random access memory, etc.), non-volatile (e.g., read only memory, flash memory, etc.), or a combination thereof.

In one configuration, software for implementing one or more embodiments disclosed herein may be stored in the storage 830. In another configuration, the memory 820 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 810, cause the processing circuitry 810 to perform the various processes described herein.

The storage 830 may be magnetic storage, optical storage, and the like, and may be realized, for example, as flash memory or other memory technology, compact disk-read only memory (CD-ROM), Digital Versatile Disks (DVDs), or any other medium which can be used to store the desired information. The storage 830 may store, among other things, a student model (e.g., the cloud model 135) trained and utilized as described herein.

The network interface 840 allows the cloud analyzer 130 to communicate with, for example, the edge analyzer 120, the data stores 140, the content sources 160, combinations thereof, and the like.

It should be understood that the embodiments described herein are not limited to the specific architecture illustrated in FIG. 8, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for visual content processing, comprising:
obtaining a subset of media content selected based on outputs of a first machine learning model, wherein the first machine learning model is produced by training a student model using outputs of a teacher model, wherein the outputs of the first machine learning model include a plurality of first predictions for a plurality of portions of the media content; and
applying a second machine learning model to the obtained subset of media content, wherein the second machine learning model outputs a plurality of second predictions for respective portions of the plurality of portions, wherein a domain used by the first machine learning model is a subset of a domain used by the second machine learning model.

2. The method of claim 1, further comprising:
training the student model using the teacher model, wherein a domain used by the student model is a subset of a domain used by the teacher model; and
sending, from a second system to a first system, the trained student model for deployment as the first machine learning model at the first system, wherein the first system is remote from the second system.

3. The method of claim 2, wherein the media content is second media content, wherein training the student model using the teacher model further comprises:
applying the student model to first media content in order to output a plurality of student predictions;
selecting a subset of the first media content based on the plurality of student predictions;
applying the teacher model to the selected subset of the first media content in order to output a plurality of teacher predictions; and
tuning the student model based on the plurality of teacher predictions, wherein the first machine learning model is created based on the tuned student model.

4. The method of claim 3, wherein tuning the student model using the plurality of teacher predictions further comprises:
generating a plurality of teacher prediction labels based on the plurality of teacher predictions, wherein the plurality of teacher prediction labels is used to tune the student model.

5. The method of claim 1, further comprising:
enriching the subset of media content based on the plurality of second predictions to create a set of enriched media content.

6. The method of claim 5, further comprising:
sending the set of enriched media content to be used for populating a dashboard.

7. The method of claim 1, wherein the first machine learning model is applied by an edge device deployed locally with respect to a source of the media content, wherein the second machine learning model is deployed remotely from the edge device.

8. The method of claim 1, wherein each of the first machine learning model and the second machine learning model is a classifier, wherein the first machine learning model is configured to output a plurality of first classes, wherein the second machine learning model is configured to output a plurality of second classes, wherein the plurality of first classes is a subset of the plurality of second classes.

9. A non-transitory computer readable medium having stored thereon instructions for causing a processing circuitry to execute a process, the process comprising:
obtaining a subset of media content selected based on outputs of a first machine learning model, wherein the first machine learning model is produced by training a student model using outputs of a teacher model, wherein the outputs of the first machine learning model include a plurality of first predictions for a plurality of portions of the media content; and
applying a second machine learning model to the obtained subset of media content, wherein the second machine learning model outputs a plurality of second predictions for respective portions of the plurality of portions, wherein a domain used by the first machine learning model is a subset of a domain used by the second machine learning model.

10. A system for visual content processing, comprising:
a processing circuitry; and
a memory, the memory containing instructions that, when executed by the processing circuitry, configure the system to:
obtain a subset of media content selected based on outputs of a first machine learning model, wherein the first machine learning model is produced by training a student model using outputs of a teacher model, wherein the outputs of the first machine learning model include a plurality of first predictions for a plurality of portions of the media content; and
apply a second machine learning model to the obtained subset of media content, wherein the second machine learning model outputs a plurality of second predictions for respective portions of the plurality of portions, wherein a domain used by the first machine learning model is a subset of a domain used by the second machine learning model.

11. The system of claim 10, wherein the system is further configured to:
train the student model using the teacher model, wherein a domain used by the student model is a subset of a domain used by the teacher model; and
send, from a second system to a first system, the trained student model for deployment as the first machine learning model at the first system, wherein the first system is remote from the second system.

12. The system of claim 11, wherein the media content is second media content, wherein the system is further configured to:
apply the student model to first media content in order to output a plurality of student predictions;
select a subset of the first media content based on the plurality of student predictions;
apply the teacher model to the selected subset of the first media content in order to output a plurality of teacher predictions; and
tune the student model based on the plurality of teacher predictions, wherein the first machine learning model is created based on the tuned student model.

13. The system of claim 12, wherein the system is further configured to:
generate a plurality of teacher prediction labels based on the plurality of teacher predictions, wherein the plurality of teacher prediction labels is used to tune the student model.

14. The system of claim 10, wherein the system is further configured to:
enrich the subset of media content based on the plurality of second predictions to create a set of enriched media content.

15. The system of claim 14, wherein the system is further configured to:
send the set of enriched media content to be used for populating a dashboard.

16. The system of claim 10, wherein the first machine learning model is applied by an edge device deployed locally with respect to a source of the media content, wherein the second machine learning model is deployed remotely from the edge device.

17. The system of claim 10, wherein each of the first machine learning model and the second machine learning model is a classifier, wherein the first machine learning model is configured to output a plurality of first classes, wherein the second machine learning model is configured to output a plurality of second classes, wherein the plurality of first classes is a subset of the plurality of second classes.

18. A method for visual content processing, comprising:
applying a first machine learning model to media content, wherein the first machine learning model is produced by training a student model using outputs of a teacher model, wherein the first machine learning model outputs a plurality of predictions for the media content;
selecting a subset of the media content based on the plurality of predictions output by the first machine learning model; and
providing the selected subset of media content as inputs to a second machine learning model, wherein a domain used by the first machine learning model is smaller than a domain used by the second machine learning model.

19. The method of claim 18, wherein the media content includes a plurality of images, further comprising:
cropping from among the plurality of images based on the plurality of predictions output by the first machine learning model in order to create a plurality of cropped images, wherein the selected subset of the media content includes the plurality of cropped images.
